(19) United States
(12) Patent Application Publication
(10) Pub. No.: US 2017/0161744 A1
(43) Pub. Date: Jun. 8, 2017

(54) System and Method for Cash Withdrawal

(71) Applicants: Rohit Gupta, Naperville, IL (US); Yash Pal Gupta, Naperville, IL (US)

(72) Inventors: Rohit Gupta, Naperville, IL (US); Yash Pal Gupta, Naperville, IL (US)

(21) Appl. No.: 15/233,789

(22) Filed: Aug. 10, 2016

Related U.S. Application Data
(60) Provisional application No. 62/263,627, filed on Dec. 5, 2015.

(51) Int. Cl. G06Q 20/40; G06Q 20/10

(52) U.S. Cl. CPC G06Q 20/4014; G06Q 20/10

(57) ABSTRACT

A cash withdrawal system and method are provided. The system enables the withdrawal of cash associated with a withdrawal cash user at merchant locations.

This application claims the benefit of U.S. patent application Ser. No. 62/263,627, filed on Dec. 5, 2015.

### FIELD OF THE INVENTION

This invention relates in general to systems and methods for cash withdrawal.

### BACKGROUND OF THE INVENTION

A person often needs cash currency in order to complete transactions where credit cards, debit cards, or other non-cash payment means are either not accepted or not convenient. A person can obtain cash by going to a branch of a bank in person and requesting cash from the person's bank account. Cash can also be obtained by going to a branch of a bank in person and presenting a debit card, a check, or other instrument that is redeemable for cash.

A person may also obtain cash by going to automated teller machines (ATMs). A person can use a debit card, a check card, a credit card, or a bank card together with other credentials to withdraw cash from an ATM.

The present inventor recognized that ATMs are often not conveniently located. The present inventor recognized that ATMs often charge the user a fee to withdraw cash. The present inventor recognized a need for a means of obtaining cash without the need of carrying a debit card, a check card, a credit card, a bank card, or the like.

The present inventor recognized the need for a system that will reduce the incidence of fraud in financial transactions. The present inventor recognized the need for a photo verified system of withdrawing funds while drawing foot traffic to merchants.

### SUMMARY OF THE INVENTION

A cash withdrawal system and method are disclosed. In some embodiments, the system comprises a transfer authority. In some embodiments, the system comprises a withdrawal user device, a merchant device, and a transfer authority device.

In some embodiments, the withdrawal user device comprises a withdrawal request transmitting function, a token receiving function, and a cash withdrawal redemption function. The withdrawal request transmitting function sends, via a computer network, a cash withdrawal request to the transfer authority device. The token receiving function receives a cash withdrawal token from the transfer authority device. The cash withdrawal redemption function displays or transmits the cash withdrawal token for receipt by the merchant device.

In some embodiments, the transfer authority device comprises a cash withdrawal token providing function, a photo sending function, and a cash dispensation authorization function. The cash withdrawal token providing function provides the cash withdrawal token corresponding to the withdrawal user device based on the cash withdrawal request. The photo sending function sends via the computer network a photo corresponding to the withdrawal user, identified in a cash distribution request, received from the merchant device. The cash dispensation authorization function sends, via the computer network, a cash dispensation authorization to the merchant device authorizing the dispensation of cash, corresponding to the cash distribution request, to the withdrawal user at the merchant location if a photo identity confirmation is received from the merchant device based on the photo sent by the photo sending function and if sufficient funds associated with the withdrawal user are available.

In some embodiments, the merchant device comprises a cash withdrawal token receiving function and a cash distribution notification function. The cash withdrawal token receiving function receives the cash withdrawal token from the withdrawal user device. The cash distribution notification function notifies a merchant user to provide the withdrawal user with cash corresponding to the cash distribution request at the merchant location if the merchant device receives the cash dispensation authorization from the transfer authority device.

Numerous other advantages and features of the present invention will become readily apparent from the following detailed description of the invention and the embodiments thereof, from the claims, and from the accompanying drawings.

### BRIEF DESCRIPTION OF THE DRAWINGS

FIG. 1 is a block diagram of an exemplary operating environment for a funds disbursement system of the invention.

FIG. 2 is a block diagram of the funds disbursement system of FIG. 1.

FIG. 3 is a flow diagram of a user account creation function of the funds disbursement system.

FIG. 4 is a block diagram of a user record of the funds disbursement system.

FIG. 5 is a block diagram of a merchant account record of the funds disbursement system.

FIG. 6 is a block diagram of a token record of the funds disbursement system.

FIG. 7 is a flow diagram of a cash withdraw request function of the funds disbursement system.

FIG. 8 is a flow diagram of a cash distribution function of the funds disbursement system.

FIG. 9 is a block diagram of an exemplary client architecture usable with the funds disbursement system.

FIG. 10 is a block diagram of a second exemplary client architecture usable with the funds disbursement system.

FIG. 11 is a block diagram of an exemplary server architecture usable with the funds disbursement system.

### DETAILED DESCRIPTION

The following description is presented to enable any person skilled in the art to make and use the invention. For the purposes of explanation, specific nomenclature is set forth to provide a plural understanding of the present invention. While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

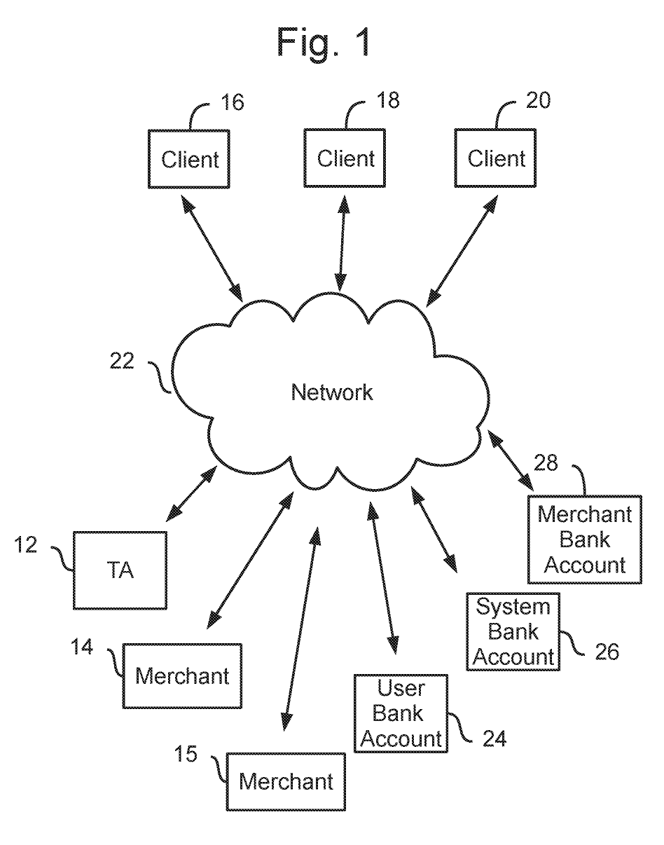

FIG. 1 shows an example operating environment for a funds disbursement system 10. In one embodiment, the funds disbursement system 10 comprises a user client 16, 18 or 20, a transfer authority 12, and a merchant client 14, 15. The user client may be operated on or implemented in a user device. The transfer authority may be operated on or implemented in a transfer authority computer. The merchant client may be operated on or implemented in a merchant device.

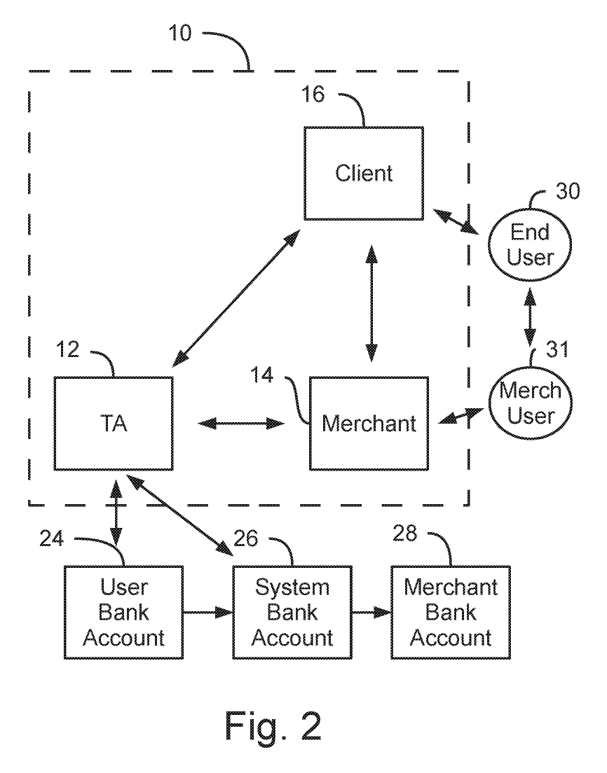

FIG. 1 shows that multiple user clients 16, 18, 20 can connect to the transfer authority 12 across the network 22. FIG. 2 shows communications and instruction routes between the various components of the system 10 across the network 22, such as shown in FIG. 1.

While three user clients are shown in FIG. 1, any number of user clients can connect and be usable with the funds disbursement system 10. The network 22 may comprise a local area network, a personal area network, a wide area network such as the Internet, or a combination of one or more such networks or other networks. The merchant clients 14, 15 are in communication with the transfer authority 12 across the network 22. While two merchant clients are shown in FIG. 1, any number of merchant clients can connect and be usable with the funds disbursement system 10.

The transfer authority 12 is in electronic or signal communication with a system bank account 26. The system bank account is a bank account associated or controlled by the transfer authority or the funds disbursement system, or an entity that owns or controls the transfer authority or the funds disbursement system. The system bank account may hold funds for one or more users between when funds are received from a user bank account 24 and when funds are transmitted to a merchant bank account 28 or are otherwise withdrawn.

The transfer authority may also be in communication with a user bank account 24 and optionally a merchant bank account 28 across the network 22. The user bank account is associated with an end user, such as user 30, of the funds disbursement system. The transfer authority may be in communication with many different user bank accounts, each corresponding to end users of the system. The transfer authority may be in communication with many different merchant bank accounts, each corresponding to merchant users, such as merchant user 31, of the system.

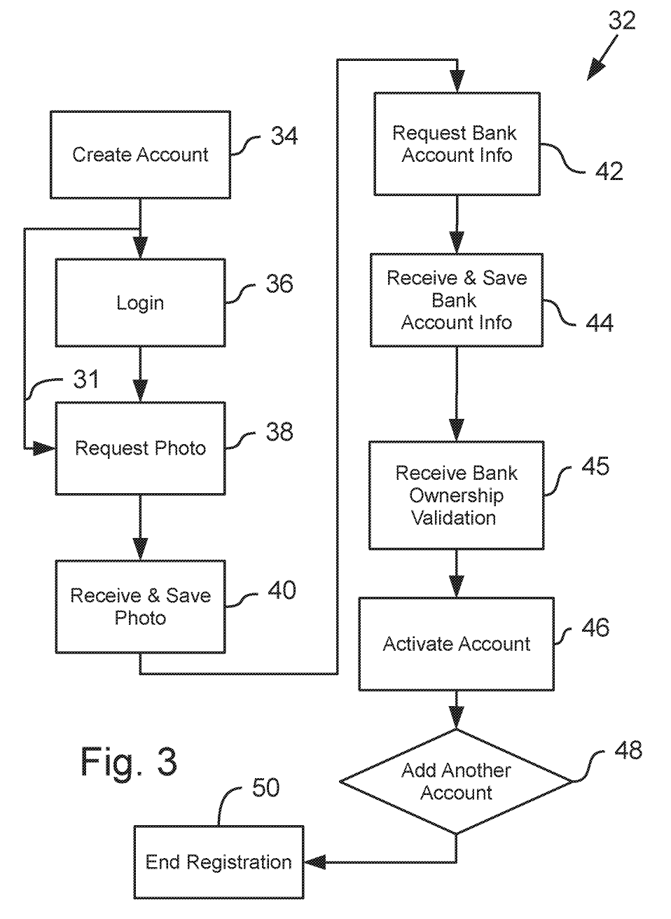

A user 30 may create a user account with the system 10. An exemplary user account creation function 32 is shown in FIG. 3. The transfer authority 12 may comprise a user database.

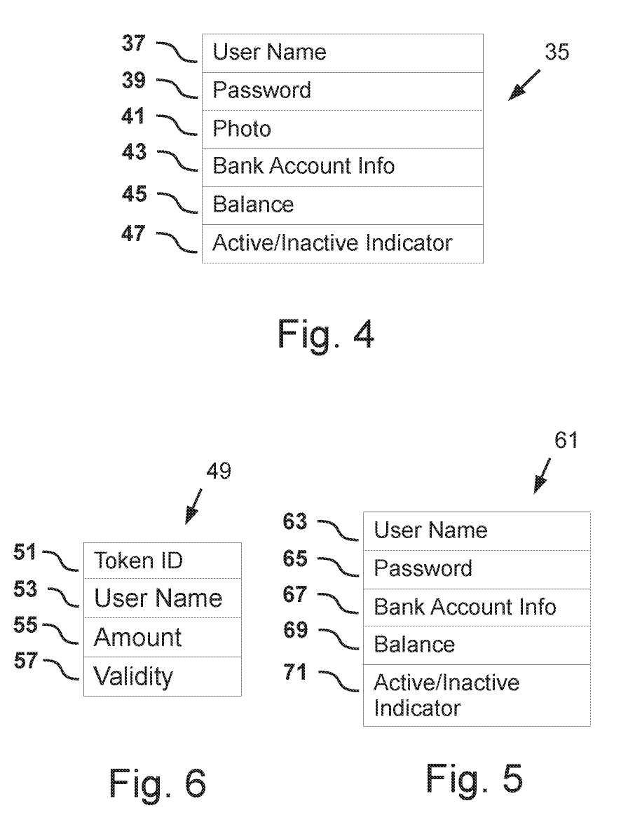

The user database may comprise a plurality of user records, such as exemplary end user record 35 shown in FIG. 4, each end user record corresponding to an end user 30.

The end user can access the user account creation function 32 via the user client 16. In some embodiments the user client 16 comprises an application running on a computing device, such as a client device, which may have a client architecture 100 or 160. The user application can be downloaded via the network 22 and installed on the client device. In some embodiments, the user client functions and operations may be accessible via a web browser running on the client device, as a software as a service, over the network from a remote computing device such as the transfer authority. Therefore, in some embodiments, the user client functionality is hosted on the transfer authority and made available to the user device via a web browser interface on the user device.

At step 34, the user account creation function 32, prompts the user to enter a username and a password into the client device, which are then transferred to the transfer authority 12 from the user client 16 into a username section 37 and password section 39 of a corresponding user record 35. In some embodiments, other authentication credentials other than or in addition to a password are requested and stored in the user record. At step 34 the function 32 may also request and receive additional information about the user such as the user's name, address, phone number, email address, and/or other information about the user. The additional information about the user may also be stored in the user record 35. In some embodiments, the username is a unique username.

At step 36, the function 32 requests the username and password and/or other authentication credentials from the user. After the user enters such information the user client 16 transfers that information to the transfer authority 12 which compares the information against the information in the user database and determines whether the authentication information provided matches that in the user database. If the username and password and/or other authentication credentials from the user are validated against the previously provided information, then the function 32 proceeds to step 38. In some embodiments, the function 32 skips step 36, does not require a login, and proceeds directly from step 34 to step 38 as shown by path 31.

At step 38, function 32 requests a photo of the user. Function 32 may provide the user the opportunity to access camera functionality on the user device operating the user client 16. The user may use the camera functionality to take a photo of himself or herself. The camera functionality of the user device may then capture and transfer the photo to the function 32 at step 40. In some embodiments, the user is provided with an opportunity to select an existing photo located on the user device, or located on a remote device via the network 22. The user client 16 will transfer the photo taken, received, or selected to the transfer authority 12. The transfer authority 12 will store the photo taken, received, or selected in the photo section 41 of the corresponding user record 35 in the user database. In some embodiments, the transfer authority will store the photo outside of the user record and the photo section 41 will contain a link to the location of the photo.

At step 42, function 32 will request bank account information from the user. The bank account information may comprise a bank routing number, a bank account number, a type of bank account, a name of the bank corresponding to the bank routing number, an account holder name corresponding to the bank account number, and/or other information related to the bank, the bank account, and or the account holder. At step 44, the function 32 receives and transfers the bank account information from the user client 16 to the transfer authority 12 where the transfer authority stores the bank account information in the bank account information section 43 of the corresponding user record 35.

At step 45, function 32 may carry out a bank account ownership verification function. The verification function may deposit one or more small amounts into the bank account identified in the bank account information. Then the verification function may ask the user to enter the one or more small amounts that have been deposited in the user's account. Therefore the user will need to have access to the bank account to discover the actual amounts of the one or more small amounts that were deposited into the user's bank account. Other bank account ownership verification procedures can also or alternatively be used.

At step 46, function 32 activates the user account. Function 32 may activate the user's account by flagging active an active/inactive section 47 of the user record 35. In some embodiments, the steps 34, 38 and 40, and 42 and 44 are provided in a different order than are shown in FIG. 3. Therefore, the system can receive the user account information, such as user information, the user photo, and user bank account information in any order and such information can be saved to the user account record. In some embodiments, some or all of the information of the user record is stored outside of the user record and the user record links to or is associated with the information or the information is linked to or is associated with the user record.

At step 48, the function 32 may optionally ask the user 30 whether the user would like to add another bank account to the user's account. If the user 30 indicates that the user does want to add or link another bank account, then function 32 returns to step 42 and repeats steps 42 through 44 for the additional bank account information. If at step 48 the user indicates the user does not want to add another bank account then function 32 ends at step 50.

The system 10 comprises a merchant account creation function, which is similar to the user account creation function 32. The merchant account creation function is configured to request and receive a user name, a password, and bank account information and to save such information into or associated with the corresponding sections of a merchant record 61, such as a user name section 63, a password section 65, and a bank account information section 67. A record or amount of funds owed to the merchant can be recorded in a balance section 69 of the merchant record. The status of the merchant account can be specified in the active/inactive indicator section 71 of the merchant record 61. The merchant account record can be saved in a merchant account database on or associated with the transfer authority. In some embodiments, the merchant account records and the user account records are stored in the same database and each respective account record comprises a type section where the type of user record is specified.

The merchant can access the merchant account creation function via the merchant client 14. In some embodiments, the merchant client 14 comprises an application running on a computing device, such as a merchant device, which may have the architecture 100 or 160. The application can be downloaded via the network 22 and installed on the merchant device.

In some embodiments, the user client functions and operations are accessible via a web browser running on the merchant device, as a software as a service, over the network from a remote computing device, such as the transfer authority. Therefore, in some embodiments, the merchant client functionality is hosted on the transfer authority and made available to the merchant device via a web browser interface on the merchant device.

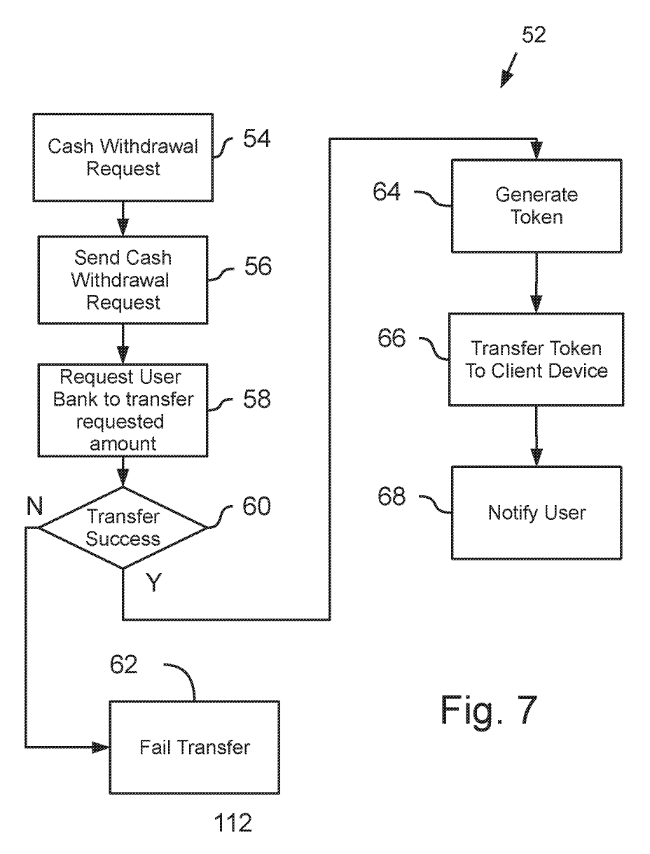

FIG. 7 shows an exemplary cash withdraw request function 52. Using the user client 16, the user 30 initiates a cash withdrawal request at step 54. The cash withdrawal request will specify a withdrawal amount. It may also specify the bank account to withdrawal from, particularly in the case where multiple bank accounts are linked or defined in the user record 35. In some embodiments, the system will store the user defined or system defined default bank account when the user has more than one bank account defined in the user record 35. At step 56, the user client 16 will transfer the cash withdrawal request to the transfer authority 12 for processing. The cash withdrawal request will comprise or will be associated with the username or user identifier associated with the user making the cash withdrawal request.

In some embodiments, the transfer authority 12, will upon receiving a cash withdrawal request initiate, at step 58, a funds transfer of the withdrawal amount, from the bank account specified in the cash withdrawal request or from the default bank account specified in the corresponding user record, to a system bank account 26. If at step 60, the transfer from the user account fails or is denied for any reason, such as there being an insufficient amount of funds in the user's bank account, then function 52 will proceed to step 62 and fail the transfer. In some embodiments, upon failing the transfer, the transfer authority 12 will send notice to the user client 16, which will display to the user or otherwise notify the user that the user's request could not be fulfilled. The failure notification may include reasons why the failure occurred, such as notifying the user that there are insufficient funds in the user's linked bank account. The system may then offer the user the option to link to another bank account and try again with the withdrawal request beginning at step 54.

In some embodiments, the system is configured to allow the user to maintain a balance with the system. If the user maintains a balance, the user's balance will be saved or associated with the user record 35, such as in the balance section 45. The user 30 may create a balance associated with the user record 35 of the user by transferring funds from the user's bank account 24 to a system bank account 26. The amount of the funds transferred will then be added to the balance associated with the user record. If a balance is allowed and maintained on or in association with the user account, then at step 58, instead of requesting a bank account transfer, the system can debit or subtract from the account balance in or associated with the user record in the amount of the withdrawal amount provided in the cash withdrawal request. If the withdrawal amount is greater than the account balance, either the system can fail at step 62 or the system can attempt to obtain the deficiency from the bank account, if one is provided, specified in the cash withdrawal request, from the default bank account specified in the corresponding user record, or from anther bank account associated with the user. If the attempt to obtain the deficiency from the user's bank account is successful, the system will debit the account balance to zero and proceed to step 60. In some embodiments, the system may require the user to maintain a minimum account balance.

If at step 60 the transfer from the user's bank account is successful or the user's account balances is successfully debited, function 52 will proceed to step 64 where the function 52 will generate at the transfer authority 12 a cash withdraw token. The cash withdraw token may be stored in a token ID section 51 of a token record 49. The token record 49 may be stored in a token database at the transfer authority 12. The token record 49, as shown in FIG. 6, may comprise a user name corresponding to the user or user account of the user making the corresponding cash withdrawal request in the user section 53, a token amount corresponding to the withdrawal amount in the token amount section 55, and a token validity indicator indicating whether or not the token is valid in the token validity section 57.

The cash withdraw token will be transferred to the user client 16 at step 66. The user client 16 will notify the user that the cash withdrawal request has been successful. At step 68 the function 52 may provide the user with additional information about where the user can pick up the cash. In some embodiments, the system 10 will utilize location functionality of the user device operating the user client 16, and will provide to the user a list or a map, on the display of the user device, of nearby locations where the cash corresponding to the cash withdraw token can be picked up by the user.

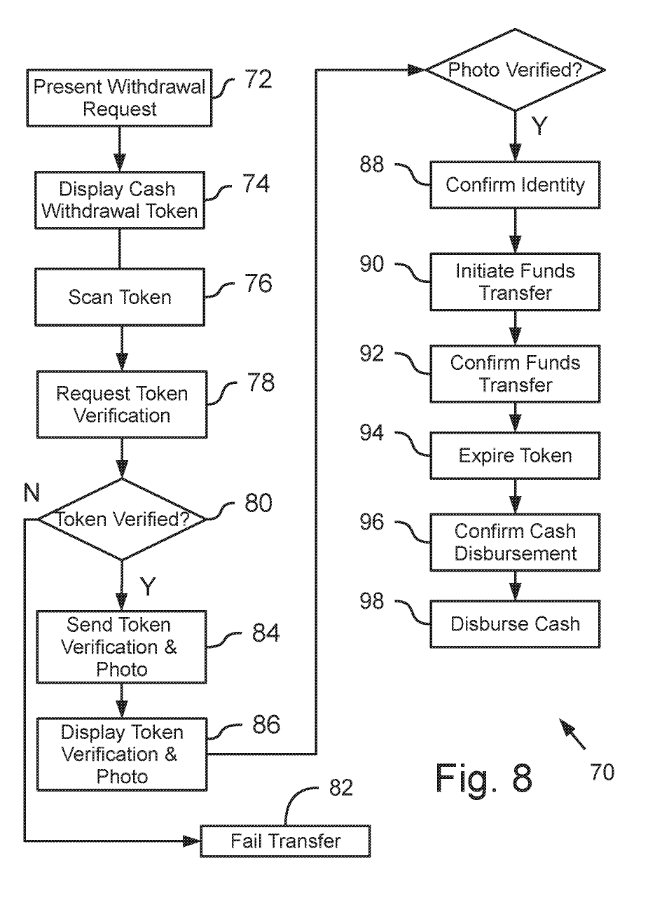

FIG. 8 shows an exemplary cash distribution function 70 of the system 10. At step 72 the user visits a participating merchant or other non-bank establishment. In some applications, the participating merchant may be a retail store, convenience store, restaurant, gas station, ticket counter, airline, bank, service center, or any ride sharing service.

At step 74, the user client 16, in response to the action by the user 30, displays the cash withdraw token on a display of the user device operating the user client. At step 76, the cash withdraw token being displayed is scanned, read, or otherwise received by the merchant client 14. In some embodiments, the token is conveyed to the merchant client from the user client by means other than display, such as by wireless communication or by audio signals. In some embodiments, a merchant user 31 at the merchant client, such as an employee, may be the person who scans or reads or otherwise provides or enters into the merchant client 14 the cash withdraw token. The merchant user 31 may cause or allow the merchant client to scan the token, using a camera, scanner, or other device integrated with or connected to the merchant device operating the merchant client. In some embodiments, the user client need not be connected to the network 22 in order to display, announce, or transmit the cash withdraw token, instead such a cash withdrawal token may be stored in the user client or client device after it is received at step 66 from the transfer authority until it is successfully redeemed.

In some embodiments, the cash withdrawal token is transferred from the user client to the merchant client using near field communication (NFC), Bluetooth® (including Bluetooth® low energy (BLE) and classic Bluetooth®), or by reading a QR Code with a sensor or camera of the user client. In some embodiments, the Bluetooth protocol is an iBeacon protocol developed by Apple Inc. of Cupertino, Calif. In some embodiments, the user may directly interface with the merchant client at a kiosks or other computing device without the assistance of a merchant user 31. And the user 30 may cause the cash withdraw token to be scanned by or transferred to the merchant client 14.

At step 78, the merchant client 14 sends the received cash withdraw token to the transfer authority 12 to verify the validity of the cash withdraw token. The transfer authority 12 compares the cash withdraw token to the token records 49 in the token database. In one example, if the received cash withdraw token matches the content of the token ID section 51 of a token record 49, then the system checks the value of the token validity section 57 to determine whether the token is valid. If the token is not valid, the transfer authority fails the transfer at step 82. The transfer authority will send notice of the failure to the merchant client, and the merchant client will then display the failure. The merchant client may also display the reason for the failure, such as the token is expired.

If the token is verified at step 80, then at step 84 the transfer authority sends verification that the token is valid to the merchant client. The transfer authority also sends a photo from or associated with the photo section 41 of the user record associated with the user name of the token record. The transfer authority sends this photo to the merchant client for display to the merchant user 31, such as an employee of the merchant, at step 86. The merchant user then compares the photo provided on the merchant client to the person 30 at the merchant presenting the cash withdrawal token, and therefore a request for the cash, to determine whether there is a match. If the merchant user 31 indicates the photo matches the person requesting the cash, the merchant user 31 indicates on the merchant client, such as by clicking or selecting an identity confirmed button, that the identity is confirmed at step 88. The merchant client then relays the identity confirmation indication to the transfer authority 12. If the transfer authority 12 receives the identity confirmation corresponding to the cash withdraw token, then at step 90 the transfer authority 12 initiates a transfer of the amount to be withdraw, as provided in the amount section 55 of the corresponding token, from the system bank account 26 to the merchant bank account 28. In some embodiments, the transfer authority does not send a verification that the token is valid to the merchant client, but instead sends the photo, which is an indication that the token is valid.

In some embodiments, the merchant client is configured to take a photo of the person requesting the cash. This may be done with the assistance of the merchant user 31. Then the merchant client may be configured to use photo recognition functionality of the merchant client to compare the photo taken to the photo received from the transfer authority. If a match is generated that the merchant client may send identity confirmation or refusal to the transfer authority. Alternatively or in addition, the merchant client may request confirmation from the merchant user 31 before sending identity confirmation or refusal to the transfer authority.

If the merchant user 31 indicates the photo does not match the person requesting the cash, the merchant user 31 indicates on the merchant client, such as by clicking or selecting an identity not confirmed button, the transfer fails and cash is not dispensed. The merchant client may communicate the failure to the transfer authority and the transfer authority by log or otherwise save the failure and information related to the failure, such as the photo the person attempting the withdrawal.

In some embodiments, the system does not initiate a bank account transfer at step 90, but instead the system credits the balance section 69 of the merchant account record corresponding to the merchant distributing the funds. Then, at a later time, such as on a daily, weekly, monthly, or other basis, the system will transfer funds corresponding to the mount specified in the balance section 69 of the merchant record from the system bank account to the merchant bank account.

At step 92, the transfer authority 12 waits for and may receive a confirmation that the funds have been transferred from the system bank account 26 to the merchant bank account 28. When it receives that confirmation, it at step 94, expires the token, such as by setting the validity section 57 of the token record 49 to an expired value. When the validity section 57 of the token record 49 is set to an expired value, if such token is presented again later token verification will fail at step 80. The transfer authority 12 sends the merchant client 14 a confirmation that cash should be disbursed based on the withdrawal request. The merchant user 31 then proceeds to provide to the user 30 an amount of cash corresponding to withdrawal request.

In some embodiments, communications between the user client 16 and the transfer authority 12 will be encrypted, communications between the merchant client 14 and the transfer authority 12 will be encrypted, and/or communications between the user client 16 and the merchant client 14 will be encrypted. In some embodiments, the communications will be encrypted using public key encryption. In public key cryptography, such as asymmetric key encryption, encryption performed with one key can be decrypted only by the other member of the key pair. Possession of one key does not enable the practical derivation of the other key. Therefore, the public key can be used to decrypt a message that was encrypted with the corresponding private key to result in the original message. And, the private key can be used to decrypt a message that was encrypted with the corresponding public key to result in the original message.

Asymmetric key encryption relies on cryptographic algorithms, which are based on mathematical problems that have no efficient solution, including but not limited to those in integer factorization, discrete logarithm, and elliptic curve relationships. A strength of asymmetric key encryption is in the impossibility or computational impracticality for a private key to be derived or determined from its corresponding public key. Therefore, public key can be disseminated publicly without compromising security. But the private key needs to be kept secret, such as remaining known only to the private key owner.

One exemplary algorithm for asymmetric key encryption is that generally known as RSA. One implementation of RSA is described in U.S. Pat. No. 4,405,829, which is herein incorporated by reference. Certain elliptic curve cryptography systems and other exemplary cryptography systems are described in U.S. Pat. No. 5,159,632, which is herein incorporated by reference. Other asymmetric key encryption algorithms can be used.

In some embodiments, the system 10 can be integrated with a merchant's existing point-of-sale system (POS). Under one type of integration, cash amounts to be dispensed at the point of sale can correspond to one or more UPC (Universal Product Code) or other code predefined in the POS. When a user presents a cash withdrawal request at step 72, the merchant user (or if a self-serve, merchant 14, then the user 30) can select the UPC code corresponding to the amount of cash to be dispensed. Then that UPC code is scanned or entered into the POS system and the POS will then recognize the amount of cash to be dispensed. Then the user can “pay” for that cash dispensation by proceeding with the cash distribution function 70 at step 74, as explained above. In some integrations there is one UPC code or other code corresponding to a cash dispensation item in the POS, and when scanned or entered into the POS, the POS prompts the user 30 (if self-serve), or merchant user 31 to enter the actual amount of cash to be dispensed into the POS in response to a POS prompt for that information. The user 30 (if self-serve), or merchant user 31 will then enter the amount to be dispensed corresponding to the amount displayed on the user device corresponding to the cash withdraw token.

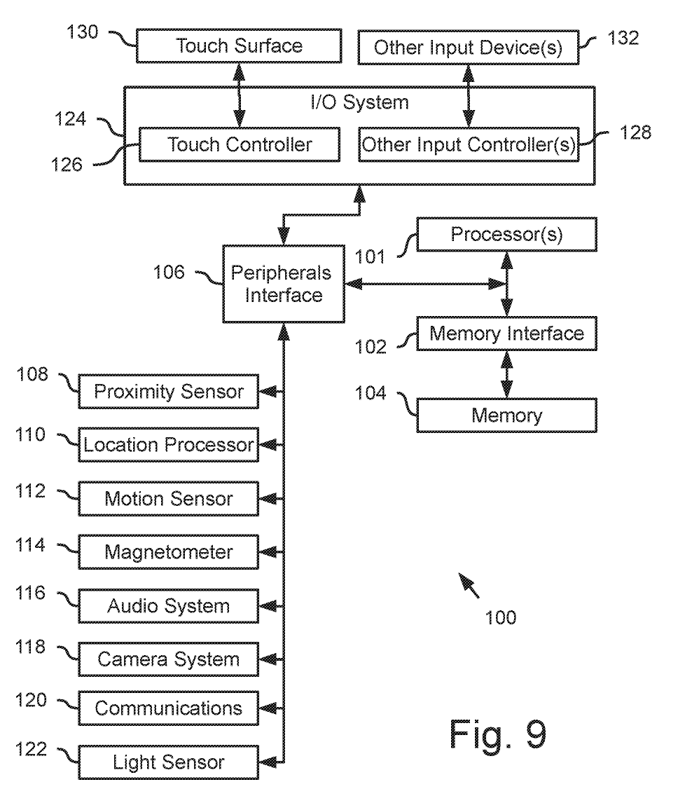

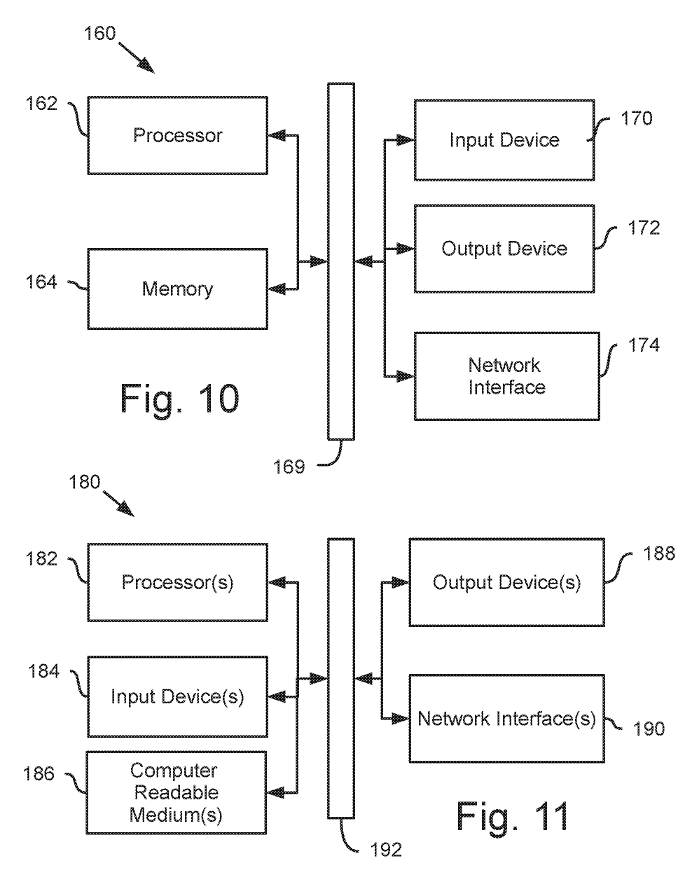

FIGS. 9 and 10 provide block diagrams of a first example client device architecture 100 and a second example client device architecture 160 for implementing the features and processes described herein, such as described in reference to the user client 16, the client device, the merchant client 14, and/or the merchant device. The architectures may be implemented in any mobile or stationary electronic device for implementing the features described herein, including but not limited to, desktop computers, portable computers, smart phones, tablet computers, wearable computers, portable electronics, and the like. In some embodiments, the merchant client and the user client are implemented on the same type of device architecture.

The architecture 100 provides a processor 101 connected to a memory interface 102 and a peripheral interface 106 across one or more internal communication channels, such as a bus(es). The memory interface 102 is coupled or otherwise signal connected to the memory 104. A proximity sensor 108, a location sensor 110, a motion sensor 112, and a magnetometer 114, an audio system 116, a camera system 118, a wireless communication system 120, and a light sensor 122 may each be connected to the peripheral interface. An input output system 124 may also be connected to the peripheral interface.

Communications capabilities and functions may be facilitated through one or more communications systems 120, such as a wireless communication system and/or a wired communications system. The wireless communications systems 120 may include radio frequency receivers and transmitters and/or optical receivers and transmitters. The wired communications system may include a port, such as a universal serial bus port, or other wired port connection that may be used to establish a wired connection to other computing devices.

The design of the communications system may correspond to the communication network(s) or medium(s) on or over which the device is intended to operate. For example, the wireless communication system may be designed to operate using standard or otherwise known protocols, such as, GPRS, enhanced data GSM environment (EDGE), IEEE 802.x (e.g., WiFi, WiMax), global system for mobile communications (GSM), code division multiple access (CDMA), Near Field Communications (NFC), Bluetooth® (including Bluetooth® low energy (BLE) and classic Bluetooth®). The wireless communication system may be configured to synchronize with a host device using one or more protocols, such as, for example, the TCP/IP protocol, HTTP protocol, UDP protocol, and any other known or standardized protocol.

The input/output system or I/O system 124 may comprise a touch controller 126 and one or more other input controllers 128. The touch controller 126 is connected to a touch surface 130. Touch surface 130 and touch controller 126 may be configured to detect contact and movement or a break of contact or a break of movement using one or more touch sensitivity technologies, such as capacitive, infrared, resistive, and surface acoustic wave technologies, as well as other proximity sensor arrays or other elements for determining one or more points of contact with touch surface 130. In one embodiment, the touch surface is configured to display a virtual keyboard and/or other virtual buttons for use as an input/output device by the user.

The other input/output controllers 128 are connectable with other input/output devices 132, such as an infrared port, a USB port, a pointer device, a rocker switch, and/or one or more other buttons. In some applications, the one or more buttons may comprise an up and down button for volume control of a speaker and/or a microphone connected to the audio system 116.

The audio system 116 may be connected to one or more speakers and one or more microphones for facilitating audio playback and for facilitating voice enabled functions, such as voice recognition, digital recording, and telephony functions. The camera system 118 may be connected to one or more cameras or optical sensors capable of capturing still image(s) and video. The optical sensor may be a complementary metal-oxide semiconductor optical sensor or a charged coupled device. The motion sensor may comprise an accelerometer and a gyroscope.

The location processor may comprise a GPS chip. The location processor may be used to provide georeferencing. The magnetometer can provide data to determine magnetic North.

The devices, systems, and sensors can facilitate multiple functionalities of the device. For example, light sensor 122, the proximity sensor 108, and the motion sensor 112 can facilitate orientation, lighting, and proximity functions of the device. In some embodiments, the motion sensor 112 may be utilized to detect movement and orientation of the device. Other sensors, such as a temperature sensor, a biometric sensor, or other sensing devices may be connected the peripherals interface 106 to facilitate related functions.

The memory 104 may comprise random access memory, non-volatile memory, such as one or more magnetic disk storage devices, one or more optical storage devices, and/or flash memory. The memory 104 may store an operating system and operating system instructions 134, such as OS X, MAC OS, IOS, TVOS, ANDROiD, Darwin, RTXC, LINUX, UNIX, WINDOWS, or VxWorks. The operating system instructions may provide for handling basic system services and for performing task involving hardware components.

The memory 104 may comprise communication instructions to facilitate communicating with one or more additional devices, one or more computers or servers, such as described herein. The memory may comprise graphical user interface (GUI) instructions to facilitate graphic user interface processing, including a touch model for interpreting touch inputs and gestures. The memory may comprise sensor processing instructions to facilitate sensor-related functions. The memory may comprise phone instructions to facilitate phone-related functions. The memory may comprise electronic messaging instructions to facilitate electronic-messaging related functions. The memory may comprise web browsing instructions to facilitate web browsing-related functions. The memory may comprise media processing instructions to facilitate media processing-related functions. The memory may comprise GPS/Navigation instructions to facilitate GPS and navigation-related functions. The memory may comprise camera instructions to facilitate camera-related functions. The memory may comprise other instructions, such as for performing some or all of the processes and functions described herein, such as regarding user client 16 and or the merchant client 14.

Each of the above identified instructions and applications may correspond to a set of instructions for performing one or more functions described above. These instructions do not need to be implemented as separate software programs, procedures, or modules. Memory 104 may include additional instructions or fewer instructions. Further, various functions of the device may be implemented in hardware and/or in software, including in one or more signal processing and/or application specific integrated circuits.

Other client architectures are possible, including architectures with more or fewer components. For example, FIG. 10 shows the second embodiment example client device architecture 160, comprising a processor 162, a memory 164, an input device 170, an output device 172, a wireless receiver or transceiver 174, and one or more internal communication channels 169 connecting the forgoing components. The architecture 160 may have an input/output device in place of a separate input device 170 and output device 172. The memory 164 may comprise random access memory, non-volatile memory, such as one or more magnetic disk storage devices, one or more optical storage devices, and/or flash memory. The client device and or merchant device may each be a stationary electronic device or a portable electronic device. In some embodiments, the merchant client will operate on a merchant's existing point-of-sale terminal(s), mobile point-of-sale devices, or point of sale (POS) systems or solutions.

FIG. 11 provides a block diagram of an example server computer architecture 180 for implementing the features and processes described herein, such as in reference to the transfer authority 12 and other server side functionality. Other architectures are possible, including architectures with more or fewer components. In some embodiments, the architecture 180 comprises one or more communication channels 192, such as a bus that connect one or more processors 182, one or more input device(s) 184, one or more output device(s) 188, one or more computer readable medium(s)186, and one or more network interface(s) 190. The one or more communication channels 192 allow the transfer of data, communications, and control signals between the various components connected to the channels 192.

The network interface(s) 190 may comprise wired or wireless network interfaces, such as an Ethernet wired network interface. The input device(s) 184 may comprise a keyboard, a mouse, and/or a touch-sensitive display. The output device(s) 188 may comprise a display, such as an LCD display. The computer readable medium(s) 186 may comprise non-volatile media, such as optical or magnetic disks, or volatile media, such as RAM or memory.

The computer readable mediums 186 may comprise an operating system, network communication instructions, and the instructions for operating the transfer authority 12. The operating system can perform tasks, such as managing files and directories on the computer storage mediums 186, managing traffic on the one or more communication channels 192, recognizing input from input devices 184, and providing output to output devices 188, among other tasks. The network communications instructions can enable the establishing, transmitting, and/or maintaining of network communications.

The steps, functions, processes, and capabilities described herein can be provided in the form of instructions stored in a computer readable medium and executable by a processor of a computing device to achieve the corresponding functions, processes, capabilities, or results.

From the foregoing, it will be observed that numerous variations and modifications may be effected without departing from the spirit and scope of the invention. It is to be understood that no limitation with respect to the specific apparatus illustrated herein is intended or should be inferred. For example, one or more component embodiments may be combined, modified, removed, or supplemented to form further embodiments within the scope of the invention. As a further example, steps provided in the flow diagrams of the figures, could be carried out in a different order to achieve desired results. Further, steps could be added or removed from the processes described. Therefore, other embodiments and implementations are within the scope of the invention.

The invention claimed is:

1. A method of authorizing a withdrawal user to withdrawal the user's funds in the form of cash currency without the use of a credit card, debit card, or bank card, comprising the steps of:
receiving on a transfer authority computer, via a computer network, a cash distribution request from a merchant device, the merchant device associated with a merchant user, the cash distribution request associated with a withdrawal user and a distribution amount;
sending via the computer network, to the merchant device, a photo corresponding the withdrawal user if the cash distribution request is valid;
sending a cash dispensation authorization to the merchant device authorizing a dispensation of the distribution amount in cash to the withdrawal user at a merchant location if a photo identity confirmation is received from the merchant device based on the photo and if an available funds associated with the withdrawal user is equal to or greater than the distribution amount, the merchant location associated with the merchant device.

2. The method of claim 1, comprising the step of
receiving via the computer network, from the merchant device, the photo identity confirmation that an identity of the withdrawal user corresponding to the cash distribution request has been photo verified based on the photo.

3. The method of claim 1, comprising the steps of
receiving on the transfer authority computer, via the computer network from a user device, a cash withdrawal request corresponding to the withdrawal user, the user device corresponding to the withdrawal user, the cash withdrawal request comprising a cash withdrawal amount;
providing to the user device a cash withdrawal token corresponding to the withdrawal user and the cash withdrawal amount if sufficient funds are available associated with the withdrawal user;
receiving at the merchant device, the cash withdrawal token from the user device;
sending the cash distribution request to the transfer authority computer from the merchant device based on the cash withdrawal token.

4. The method of claim 3, comprising the steps of
generating on the user device the cash withdrawal request; and
transmitting from the user device the cash withdrawal request to the transfer authority computer.

5. The method of claim 3, comprising the step of, before generating a cash withdrawal token, (i) requesting an electronic transfer of funds in an amount equal to the cash withdrawal amount from a user bank account to a system bank account, where the user bank account corresponds to the withdrawal user, or (ii) debiting an account balance associated with the withdrawal user by the distribution amount.

6. The method of claim 1, comprising the step of, before receiving on a transfer
authority computer via a computer network a cash distribution request, creating a user account, on the transfer authority computer, associated with a user name, an authentication credential, and the photo of the withdrawal user.

7. The method of claim 1, comprising the step of,
requesting a user name from a user client device;
requesting an authentication credential from the user client device;
requesting the photo of the withdrawal user from the user client device;
creating a user account, on the transfer authority computer, comprising the user name, the authentication credential, and the photo of the withdrawal user.

8. The method of claim 1, wherein the step of determining, comprises the step of checking a validity section of a cash distribution record corresponding to the cash distribution request to determine whether the validity section contains a value indicating that the cash distribution request is valid.

9. The method of claim 1, comprising the steps of displaying the photo on the merchant device; and prompting the merchant user, on the merchant device, to indicate whether a cash withdrawal requester at the merchant location matches the photo displayed.

10. The method of claim 1, wherein the step of receiving on a transfer authority computer, via a computer network, a cash distribution request is further defined in that the computer network comprises the internet.

11. The method of claim 1, comprising the step of before sending the cash dispensation authorization, requesting an electronic transfer of funds in an amount equal to the distribution amount from a system bank account to a merchant bank account if the photo identity confirmation is received, where the merchant bank account corresponds to a merchant associated with the merchant device.

12. The method of claim 1, comprising the step of debiting an account balance associated with the withdrawal user by the distribution amount.

13. The method of claim 1, comprising the step of crediting an account balance associated with a merchant.

14. A cash withdrawal authorizing computer, comprising:
a processor;
a memory coupled to the processor;
a photo sending function stored on the memory and executable by the processor to send, via a computer network, to a merchant device, a photo corresponding to a withdrawal user identified in a distribution request received from the merchant device, the distribution request comprising a distribution amount;
a cash dispensation authorization sending function stored on the memory and executable by the processor to send a cash dispensation authorization to the merchant device authorizing a dispensation of cash corresponding to the cash distribution request to the withdrawal user at a merchant location if a photo identity confirmation is received from the merchant device based on the photo sent by the photo sending function and if an available funds associated with the withdrawal user is equal to or greater than the distribution amount, the merchant location corresponding to the merchant device.

15. The computer of claim 14, comprising:
an identity confirmation receiving function stored on the memory and executable by the processor to receive the photo identity confirmation that an identity of the withdrawal user corresponding to the cash distribution request has been photo verified based on the photo at the merchant location.

16. The computer of claim 14, comprising:
a cash distribution request receiving function stored on the memory and executable by the processor to receive the cash distribution request via the computer network from the merchant device;
a validity determining function stored on the memory and executable by the processor to determine whether the cash distribution request is valid.

17. The computer of claim 14, comprising:
a cash withdrawal receiving function stored on the memory and executable by the processor to receive, via the computer network, a cash withdrawal request corresponding to the withdrawal user, the cash withdrawal request comprising a cash withdrawal amount;
a token sending function stored on the memory and executable by the processor to send a cash withdrawal token corresponding to the withdrawal user and the cash withdrawal amount if an available funds associated with the withdrawal user is equal to or greater than the distribution amount; the cash distribution request comprises the cash withdrawal token; and,
a cash distribution request receiving function stored on the memory and executable by the processor to receive the cash distribution request via the computer network from the merchant device, the distribution request corresponding to the cash withdrawal token.

18. The computer of claim 14, comprising:
a merchant credit function stored on the memory an executable by the processor to (i) initiate an electronic transfer of funds in an amount equal to the distribution amount from a system bank account to a merchant bank account if the photo identity confirmation is received, where the merchant bank account corresponds to a merchant associated with the merchant device or (ii) crediting an account balance associated with the merchant.

19. A cash withdrawal system, comprising:
a withdrawal user device comprising
a user processor;
a user memory coupled to the user processor;
a withdrawal request generating function stored on the user memory and executable by the user processor to generate a cash withdrawal request in response to a request by a withdrawal user;
a withdrawal request transmitting function stored on the user memory and executable by the user processor to send via a computer network the cash withdrawal request to the transfer authority device;
a token receiving function stored on the user memory and executable by the user processor to receive a cash withdrawal token from the transfer authority device;
a cash withdrawal redemption function stored on the user memory and executable by the user processor to display or transmit the cash withdrawal token for receipt by a merchant device;
a transfer authority device comprising
a transfer authority processor;
a transfer authority memory coupled to the transfer authority processor;
a cash withdrawal token providing function stored on the transfer authority memory and executable by the transfer authority processor to provide the cash withdrawal token corresponding to the withdrawal user device based on the cash withdrawal request;
a photo sending function stored on the transfer authority memory and executable by the transfer authority processor to send via the computer network a photo corresponding to the withdrawal user, identified in a cash distribution request, received from the merchant device;
a cash dispensation authorization function stored on the transfer authority memory and executable by the transfer authority processor to send a cash dispensation authorization to the merchant device authorizing a dispensation of cash corresponding to the cash distribution request to the withdrawal user at a merchant location if a photo identity confirmation is received from the merchant device based on the photo sent by the photo sending function and if sufficient funds associated with the withdrawal user are available, the merchant location corresponding to the merchant device;
the merchant device comprising
a merchant processor;
a merchant memory coupled to the merchant processor;
a cash withdrawal token receiving function stored on the merchant memory and executable by the merchant processor to receive the cash withdrawal token from the withdrawal user device;
a cash distribution notification function stored on the merchant memory and executable by the merchant processor to notify a merchant user to provide the withdrawal user with cash corresponding to the cash distribution request at the merchant location if the merchant device receives the cash dispensation authorization from the transfer authority device, the merchant location corresponding to the merchant device.
